(19) United States
(12) Patent Application Publication
(10) Pub. No.: US 2025/0282033 A1
(43) Pub. Date: Sep. 11, 2025

(54) Nut Runner Utility Device

(71) Applicants: Patrick Joseph McGill, Tempe, AZ (US); Nicholas Olberg, Scothsdale, AZ (US)

(72) Inventors: Patrick Joseph McGill, Tempe, AZ (US); Nicholas Olberg, Scothsdale, AZ (US)

(21) Appl. No.: 18/831,498

(22) Filed: Mar. 5, 2025

Related U.S. Application Data
(60) Provisional application No. 63/630,819, filed on Mar. 6, 2024.

(51) Int. Cl. B25B 13/48; B25B 21/00; B25B 23/00

(52) U.S. Cl. CPC B25B 13/48; B25B 21/007; B25B 23/0021; B25B 23/0035

(57) ABSTRACT

A nut runner utility device comprising an elongated tube body configured with a front end and a back end, said front end configured with an open socket to engage an interchangeable socket to engage a fastening nut, a square drive socket configured at said: tube body back end, said square socket configured to engage a drill or mechanical equipment to rotate said elongated tube and drive said fastening nut along the length of an all-thread rod said interchangeable socket configured to engage various diameters of all-thread rods.

### CROSS REFERENCE TO RELATED APPLICATIONS

Provisional Patent No. 63/630,819 issued on Mar. 6, 2024 to inventors Joseph Mc Gill and Nicholas Olberg.

### STATEMENT REGARDING FEDERALLY SPONSORED RESEARCH OR DEVELOPMENT

“Not Applicable”

### THE NAMES OF THE PARTIES TO A JOINT RESEARCH AGREEMENT

“Not Applicable”

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

“Not Applicable”

### STATEMENT REGARDING PRIOR DISCLOSURES BY THE INVENTOR OR JOINT INVENTORS

“Not Applicable”

### BACKGROUND OF THE PRESENT INVENTION

### (1) Field of the Invention

The field of the present invention is generally in construction, heating and cooling equipment installation, and more specifically in applications of all-thread rods and fasteners.

### (2) Background and objects of the Present Invention

The present invention is in applications of all-thread rods and a novel method of securing a fastening nut along the length of an all-thread rod, a task that is normally tedious as all-thread rods are of significant length and running a fastening nut along the length of an all-thread rod takes patience and time if done manually. Some all-thread rods can be six feet long and others can be longer, therefore securing a fastening nut can be very time consuming and adds cost to construction projects due to man hours consumed in the tedious manual method of placing a securing nut at a location along an all-thread rod.

It would therefore be advantageous to find a method of running a fastening nut along the length of an all-thread rod. An object of the present invention is to provide a tool which will place a fastening nut along an all-thread rod in an expeditious manner.

It is also an object of the present invention to provide a method of securing a fastening nut along an all-thread rod to save time and man hours in a construction project.

It is further an object of the present invention to provide a mechanical method and device for securing a fastening nut along an all-thread rod.

To further describe a background of the use of all-thread rods and the importance of saving man hours of work in various industries, presented herein is a background of various uses of all-thread rods to provide a scope of the usefulness of the present invention in many various fields.

Threaded rods, also known by several other names such as threaded studs, all-thread, all-thread rods, threaded bars, or screw rods, serve various purposes across different industries.

These are some applications:

### 1. Construction and Structural Stabilization

Threaded rods are used to stabilize structures by fastening materials together. They play a crucial role in joining wood and metal components, ensuring stability in construction projects.
In non-structural construction, threaded rods are still valuable for connecting materials.
HVAC installations benefit from threaded rods, allowing quick and precise alignment of ductwork, heaters, and air handlers.

### 2. Plumbing and Contracting

Steel or stainless-steel threaded rods are commonly used in plumbing and contracting. They facilitate the installation of pipes, fixtures, and other equipment.
Suspended ceilings can be hung using threaded rods, ensuring proper alignment.

### 3. Metalworking and Machinery

Threaded rods find applications in metalworking, including furniture assembly.
In machinery, they contribute to stability and alignment.

### 4. Electrical and Electronics

Copper threaded rods, due to their malleability and high thermal and electrical conductivity, are used in electrical applications.
They serve as heat conductors and are suitable for electrical connections.

### 5. Automotive and Aerospace

Threaded rods are utilized in automotive assembly and repair.
In the aerospace industry, they play a role in various applications.

### 6. Oil and Gas Industry

Threaded rods withstand high pressure and tension, making them useful in oil and gas facilities.

### 7. Marine Applications

Marine structures benefit from threaded rods for stability and fastening.

### 8. Ornamental and Aesthetic Uses

Threaded brass rods, often hollow, are used in lamp holders to feed wires.

Threaded rods come in various materials, including steel, stainless steel, titanium, nylon, brass, copper, and even aluminum. Each material has specific properties suited to different applications.

In a shop environment the following is a method to thread a nut along an all-thread rod. This method is tedious and would not be practical in a field environment. The present invention is adapted to field environments, and to shop fabrication.

In a shop environment, to thread a nut on an all-thread rod, you can use a thick rubber band and a bolt in a drill. Here are the steps:

1. Wrap the rubber band around the threaded rod near the end where you want to put the nut.

2. Insert a bolt that fits the nut into the drill chuck and tighten it.

3. Align the bolt with the nut and start the drill slowly.

4. The rubber band will grip the threaded rod and spin it, moving the nut along the rod.

5. Stop the drill when the nut reaches the desired position.
As previously noted, this technique is feasible in a shop environment but would be cumbersome in a field installation.

All-thread rods are versatile fasteners that can be used in a variety of applications. Here are some common uses of all-thread rods:

1. Epoxy Anchors: All-thread rods are often used as anchor bolts in pre-existing concrete. A hole is drilled into the concrete, then the hole is filled with epoxy and a piece of all-thread rod is placed in the hole. Once the epoxy bonds with the threads on the all-thread rod, it provides pullout resistance, allowing the rod to act as an anchor bolt.

2. Extenders: All-thread rods are also commonly used as extenders in the field. If anchor bolts are set too low, the easiest fix is to extend the anchor bolt with a coupling nut and a piece of threaded rod. This allows the contractor to extend the threads of the existing anchor bolt and properly tighten the nut.

3. Anchor Bolts: All-thread rods are often used as anchor bolts. They are embedded in concrete and provide pull out resistance with their fully threaded bodies, along with the help of a nut, or nut and plate combination. All-thread rod anchor bolts are commonly specified using the anchor bolt specification F134 in Grades 36, 3 and 4.

4. Pipe Flange Bolts: All-thread rods are commonly used to bolt pipe flanges together. This is especially true for A193 Grade B7 all-thread rod, which is designed for high temperature, high pressure applications. The short all-thread rod pieces bolt the pipe flanges together with nuts on each end of the rod.

5. Double Arming Bolts: All-thread rods are also used in the pole line industry as double arming bolts. This bolt type is used to secure one cross arm on each side of a wooden utility pole. The advantage to using fully threaded rods in this application is to allow for maximum adjustment for the cross arms on the poles which can vary depending on a number of factors.

6. General Applications: All-thread rods are used from time to time in virtually any construction fastening application. They are used with a nut on each end and for fastening wood, steel, and other types of construction materials. They are often substituted for a hex bolt or other type of bolt with a forged head.

Another application of all-thread rods is in suspended ceilings, a description of this application follows:

### 1. Suspended Ceilings

When installing a suspended ceiling, threaded rods play a crucial role.
   Purpose: Suspended ceilings are commonly used in commercial spaces, offices, and even residential basements. They provide a clean and finished appearance while allowing access to utilities (wiring, pipes, etc.) above the ceiling.

### Materials

Threaded Rods: These act as hangers to support the ceiling grid.
Ceiling Grid Components: Including main runners, cross tees.
Ceiling Tiles: The visible part of the ceiling.
Fasteners: Nuts, washers, and anchors.

### 2. Other Applications

Threaded rods are also used for securing heavy equipment, anchoring structural components, and creating bracing systems.
For example, in seismic retrofitting, threaded rods can be used to reinforce existing structures by connecting beams, columns, and walls.

### SUMMARY OF THE INVENTION

Disclosed herein is a nut runner utility device comprising an elongated tube body configured with a front end and a back end, said front end configured with an open hex socket to engage an interchangeable socket to engage a fastening nut and a square drive socket at said back end configured to engage a drill to rotate said elongated tube and drive said fastening nut along the length of an all-thread rod to a required location for securing equipment or duct in an overhead installation. Said interchangeable socket configured to engage various diameters of all-thread rods. Said back end configured with a square drive socket to fit a drill, ratcheting wrench, or similar mechanical drive equipment to turn said tube body in a clockwise or counterclockwise direction, thereby running a fastening nut up or down on an all-thread rod.

The present invention will allow an operator to expedite a normally time-consuming task of running a fastening nut along the length of an all-thread rod, with lengths up to six feet, used to secure equipment overhead near ceilings especially duct for heating, cooling, and ventilation of buildings. There are some techniques to run a fastening nut along an all-thread rod in a shop environment but will not be feasible in a field environment with an operator on a folding ladder working to secure equipment or ducting overhead. The present invention will allow an operator to expedite this task, saving time and man hours on a construction job.

### BRIEF DESCRIPTION OF THE DRAWINGS

FIG. 1 is a plan view of a Nut Runner 100 of the present invention showing a plan view of a front pass-through socket 2 and a tube body 1 with a handle 7 attached to handle bushing 4 and further showing a rear square drive 3.

FIG. 2 is a plan view of a Nut Runner 100 of the present invention showing a right-side view of the front pass-through socket 2 and tube body 1 with a handle 7 attached to handle bushing 4 and further showing a rear square drive 3.

FIG. 3 is a plan view of a Nut Runner 100 of the present invention showing a left side view of the front pass-through socket 2 and tube body 1 with a handle 7 attached to handle bushing 4 and further showing a rear square drive 3.

FIG. 4 is a plan view of a Nut Runner 100 of the present invention showing a rotated view of the front pass-through socket 2 and tube body 1 with a handle bushing 4 attached to a handle 7 and further showing a rear square drive 3.

FIG. 5 is an isometric view of a Nut Runner 100 of the present invention showing a front view of the front pass-through socket 2, interchangeable socket 8, and tube body 1 with a handle 7 attached to handle bushing 4 and further showing a rear square drive 3.

FIG. 6 is an isometric view of a Nut Runner 100 of the present invention showing a back view of the front pass-through socket 2 configured for driving hex head fasteners and tube body 1 with a handle 7 attached to handle bushing 4 and further showing a rear square drive 3 denoting a ⅜ inch square drive compatible with standard ratcheting wrenches, impact guns, and other drivers.

FIG. 7 is a side view of a Nut Runner 100 of the present invention showing a view of the front pass-through socket 2, interchangeable socket 8, all thread rod 30, and tube body 1 with a handle 7 attached to handle bushing 4 and further showing a rear square drive 3 coupled to a drill 35 which turns tube body 1, thereby running a fastening nut along all-thread rod 30.

FIG. 8 is a side view of the front of Nut Runner 100 of the present invention showing the front pass-through socket 2, interchangeable socket 8, and all thread rod 30.

FIG. 9 is an isometric view of Nut Runner 100 of the present invention showing the front pass through socket 2 configured with interchangeable socket 8 and tube body 1 with a handle 7 attached to handle bushing 4 further showing a rear square drive 3 coupled to a drill 35 which turns tube body 1, thereby running a fastening nut secured to interchangeable socket 8 along all-thread rod 30.

FIG. 10 is an isometric view of Nut Runner 100 of the present invention showing the front pass through socket 2 configured with interchangeable socket 8 and tube body 1 with a handle 7 attached to handle bushing 4 further showing a rear square drive 3 coupled to a drill 35 which turns tube body 1, thereby running a fastening nut secured to interchangeable socket 8 along all-thread rod 30.

FIG. 11 is an isometric exploded view of Nut Runner 100 of the present invention showing the front pass-through socket 2 configured with interchangeable socket 8 and tube body 1 with a handle 7 to be fitted onto weld nut 6 further to be attached to attached to handle bushing 4, bushing 5 to be fitted into handle bushing 4 and further showing a rear square drive 3.

FIG. 12 is an isometric view of front pass-through socket 2, further showing side and front views of pass-through socket 2.

FIG. 13 is an isometric view of rear square drive 3, further showing side and front views of rear square drive 3.

FIG. 14 is an isometric view of handle bushing 4 showing a weld nut 6 welded onto handle bushing 4, said welded nut to engage threads of handle 7.

FIG. 15 is a side view of weld nut 12 welded to handle bushing 4.

FIG. 16 is a front view of weld nut 6 welded to handle bushing 4.

FIG. 17 is an isometric view of bushing 5 that will fit into handle bushing 4 to allow rotation of tube body 1 while an operator is holding handle 7.

FIG. 18 is an isometric view of tube body 1 assembled with pass-through socket 2 welded onto tube body 1 and square drive 3 welded onto tube body 1.

FIG. 19 is an isometric view of assembly of handle 7 to be configured into weld nut 6 and further showing bushing 5 to be inserted into handle bushing 4.

FIG. 20 is an isometric view of handle bushing 4 showing its assembly onto tube body 1.

FIG. 21 is an isometric view of tube body 1 further showing a side view and front view of tube body 1 with preferred embodiment.

### DESCRIPTION OF THE INVENTION

Reference is made to claim filing date of Provisional Patent No. 63/630,819 issued on Mar. 6, 2024 to inventors Joseph Mc Gill and Nicholas Olberg.

The present invention will allow an operator to expedite a normally time-consuming task of running a fastening nut along the length of an all-thread rod, with lengths up to six feet, used to secure equipment overhead near ceilings especially duct for heating, cooling, and ventilation of buildings. There are some techniques to run a fastening nut along an all-thread rod in a shop environment but will not be feasible in a field environment, with an operator on a folding ladder working to secure equipment or ducting overhead. The present invention will allow an operator to expedite this task, saving time and man hours on a construction job.

Disclosed herein is a nut runner utility device comprising an elongated tube body configured with a front end and a back end, said front end configured with a hex socket to engage a fastening nut and drive said fastening nut along the length of an all-thread rod to a required location for securing equipment or duct in an overhead installation. Said nut runner utility device comprising a back end configured with a square aperture drive to fit a drill, ratcheting wrench, or similar mechanical drive equipment to turn said tube body in a clockwise or counterclockwise direction, thereby running a fastening nut up or down on an all-thread rod.

To further describe the nut runner utility device, presented herein are drawings with various figures:

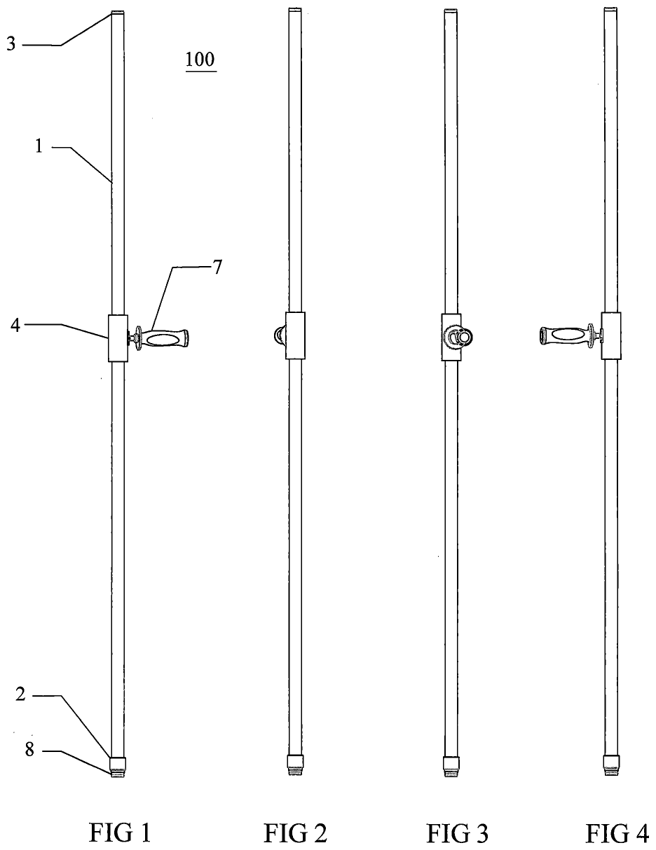

FIG. 1 is a plan view of a Nut Runner 100 of the present invention showing a plan view of a front pass-through socket 2 and a tube body 1 with a handle 7 attached to handle bushing 4 and further showing a rear square drive 3. Construction of said tube body 1 can comprise metallic pipe, metallic tubing, or nonferrous material such as fiberglass or plastic.

FIG. 2 is a plan view of a Nut Runner 100 of the present invention showing a right-side view of the front pass-through socket 2 and tube body 1 with a handle 7 attached to handle bushing 4 and further showing a rear square drive 3.

FIG. 3 is a plan view of a Nut Runner 100 of the present invention showing a left side view of the front pass-through socket 2 and tube body 1 with a handle 7 attached to handle bushing 4 and further showing a rear square drive 3.

FIG. 4 is a plan view of a Nut Runner 100 of the present invention showing a rotated view of the front pass-through socket 2 and tube body 1 with a handle bushing 4 attached to a handle 7 and further showing a rear square drive 3.

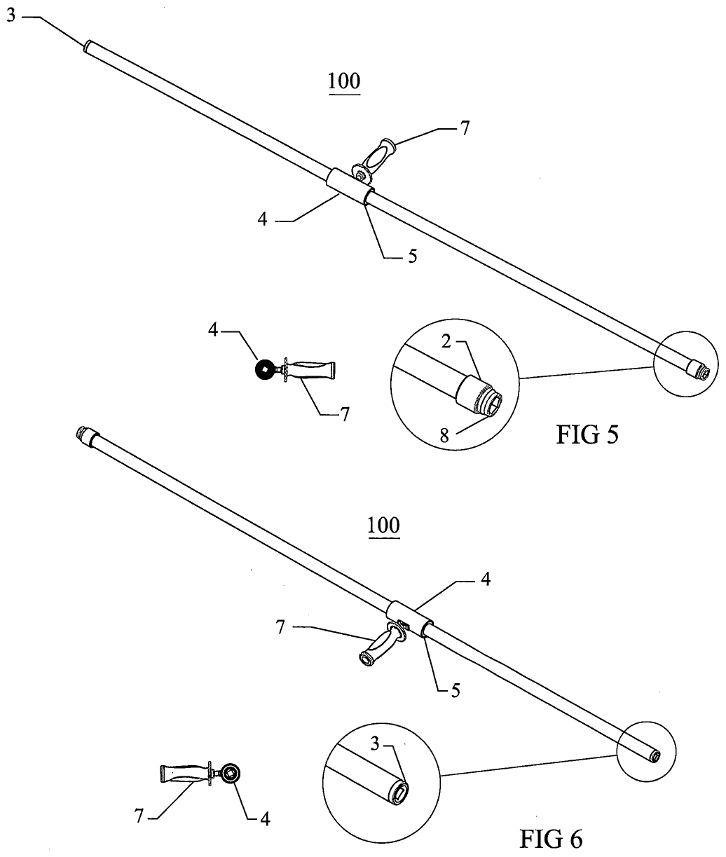

FIG. 5 is an isometric view of a Nut Runner 100 of the present invention showing a front view of the front pass-through socket 2, interchangeable socket 8, and tube body 1 with a handle 7 attached to handle bushing 4 and further showing a rear square drive 3.

FIG. 6 is an isometric view of a Nut Runner 100 of the present invention showing a back view of the front pass-through socket 2 configured for driving hex head fasteners and tube body 1 with a handle 7 attached to handle bushing 4 and further showing a rear square drive 3 denoting a ⅜ inch square drive compatible with standard ratcheting wrenches, impact guns, and other drivers.

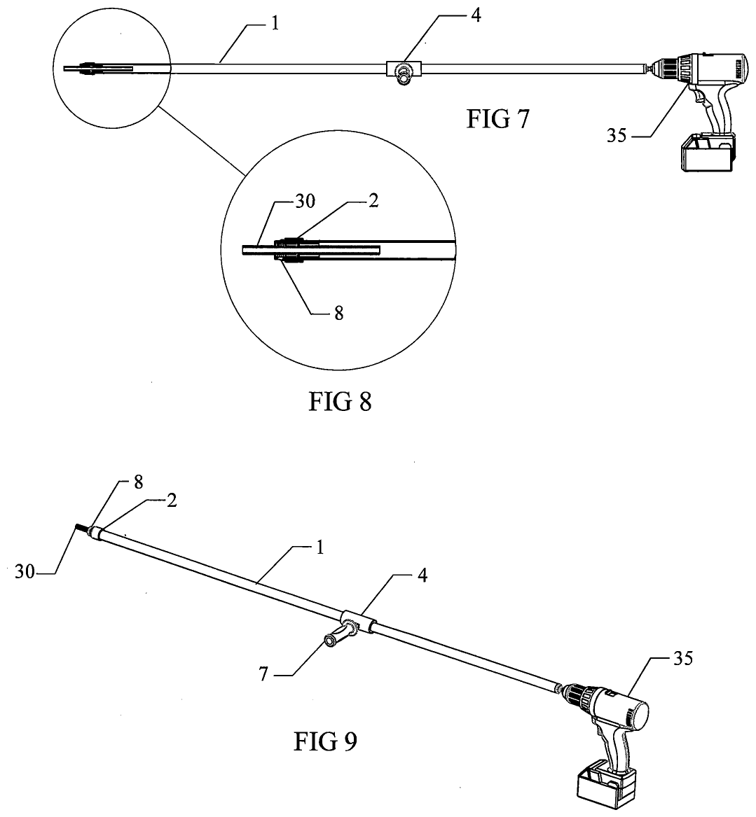

FIG. 7 is a side view of a Nut Runner 100 of the present invention showing a view of the front pass-through socket 2, interchangeable socket 8, all thread rod 30, and tube body 1 with a handle 7 attached to handle bushing 4 and further showing a rear square drive 3 coupled to a drill 35 which turns tube body 1, thereby running a fastening nut along all-thread rod 30.

FIG. 8 is a side view of the front of Nut Runner 100 of the present invention showing the front pass-through socket 2, interchangeable socket 8, and all thread rod 30.

FIG. 9 is an isometric view of Nut Runner 100 of the present invention showing the front pass through socket 2 configured with interchangeable socket 8 and tube body 1 with a handle 7 attached to handle bushing 4 further showing a rear square drive 3 coupled to a drill 35 which turns tube body 1, thereby running a fastening nut secured to interchangeable socket 8 along all-thread rod 30.

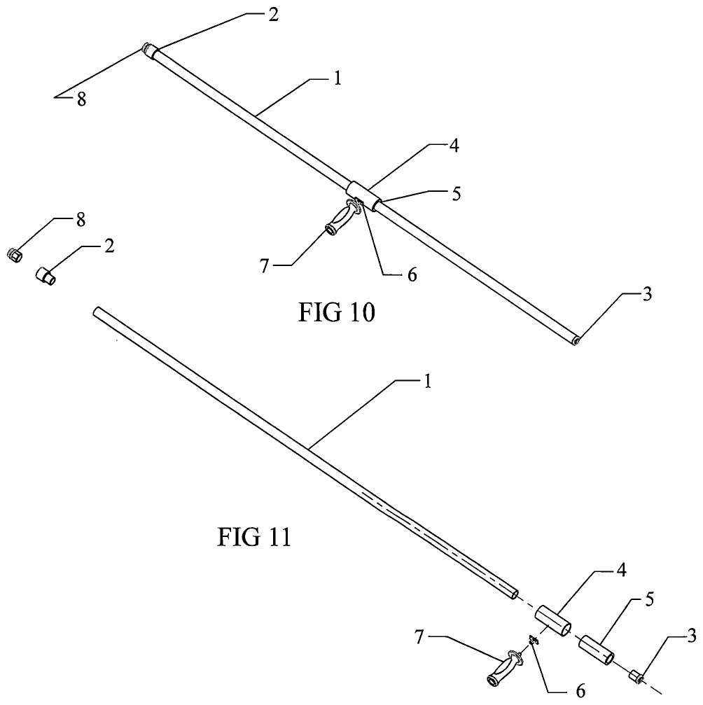

FIG. 10 is an isometric view of Nut Runner 100 of the present invention showing the front pass through socket 2 configured with interchangeable socket 8 and tube body 1 with a handle 7 attached to handle bushing 4 further showing a rear square drive 3 coupled to a drill 35 which turns tube body 1, thereby running a fastening nut secured to interchangeable socket 8 along all-thread rod 30.

FIG. 11 is an isometric exploded view of Nut Runner 100 of the present invention showing the front pass-through socket 2 configured with interchangeable socket 8 and tube body 1 with a handle 7 to be fitted onto weld nut 6 further to be attached to attached to handle bushing 4, bushing 5 to be fitted into handle bushing 4 and further showing a rear square drive 3.

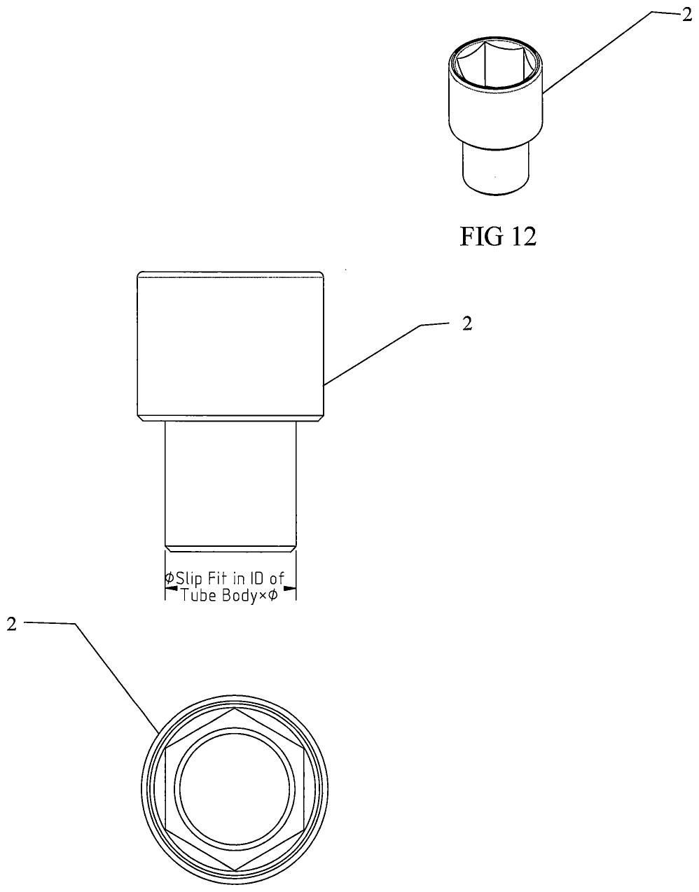

FIG. 12 is an isometric view of front pass-through socket 2, further showing side and front views of pass-through socket 2.

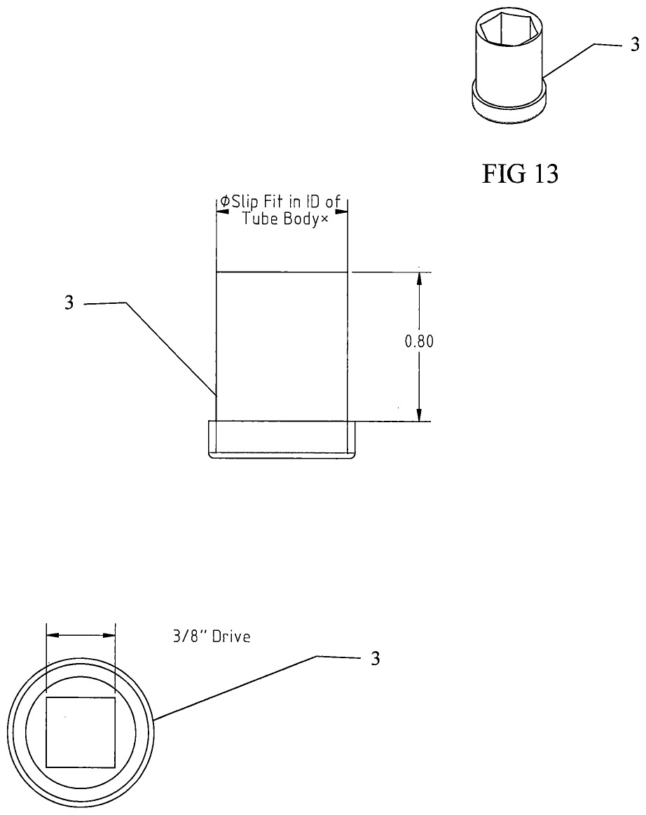

FIG. 13 is an isometric view of rear square drive 3, further showing side and front views of rear square drive 3.

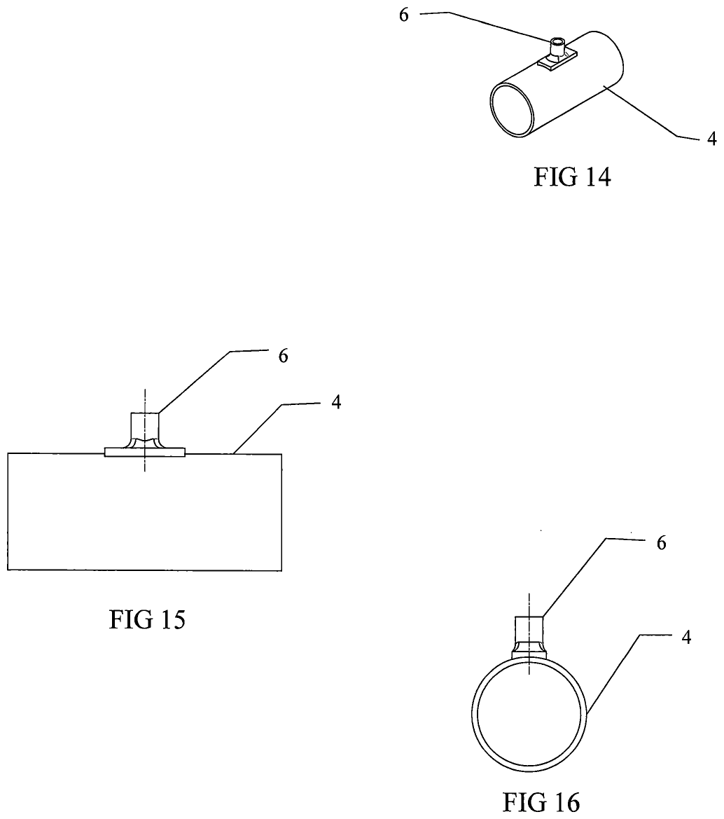

FIG. 14 is an isometric view of handle bushing 4 showing a weld nut 6 welded onto handle bushing 4, said welded nut to engage threads of handle 7.

FIG. 15 is a side view of weld nut 12 welded to handle bushing 4.

FIG. 16 is a front view of weld nut 6 welded to handle bushing 4.

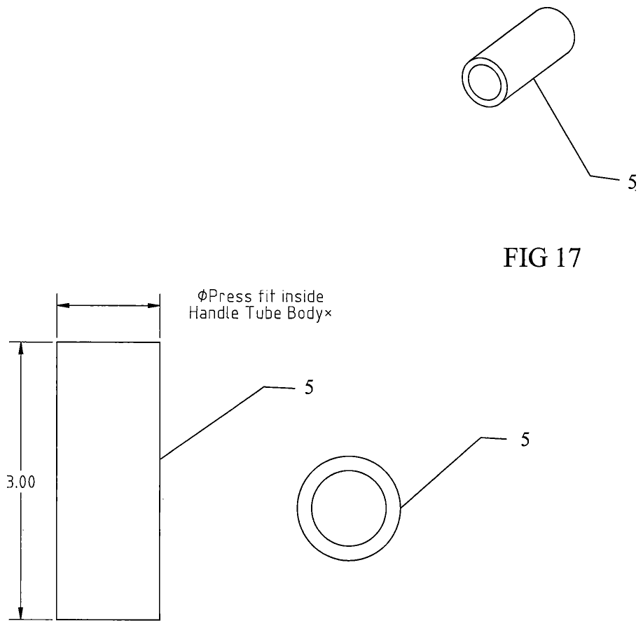

FIG. 17 is an isometric view of bushing 5 that will fit into handle bushing 4 to allow rotation of tube body 1 while an operator is holding handle 7.

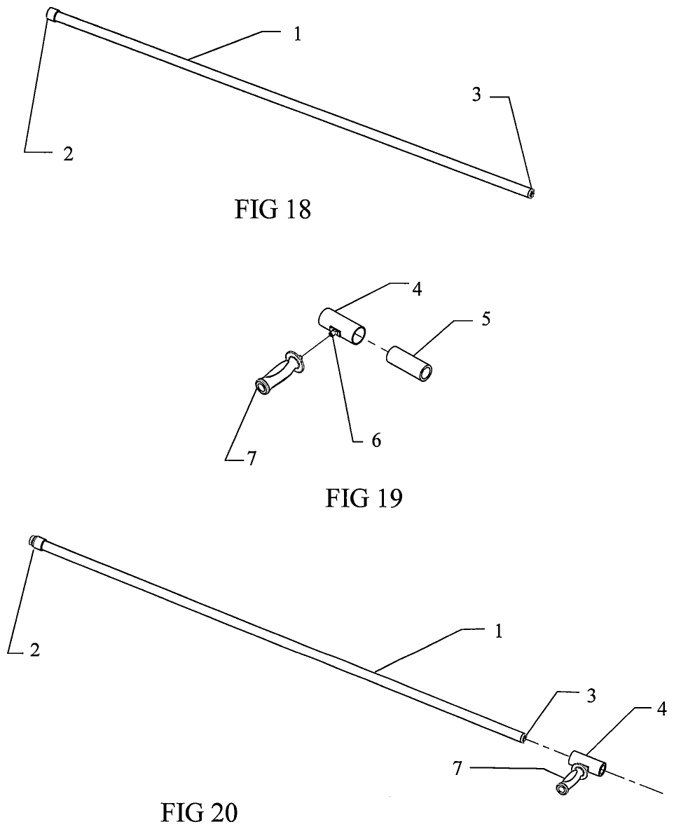

FIG. 18 is an isometric view of tube body 1 assembled with pass-through socket 2 welded onto tube body 1 and square drive 3 welded onto tube body 1.

FIG. 19 is an isometric view of assembly of handle 7 to be configured into weld nut 6 and further showing bushing 5 to be inserted onto handle bushing 4.

FIG. 20 is an isometric view of handle bushing 4 showing its assembly onto tube body 1.

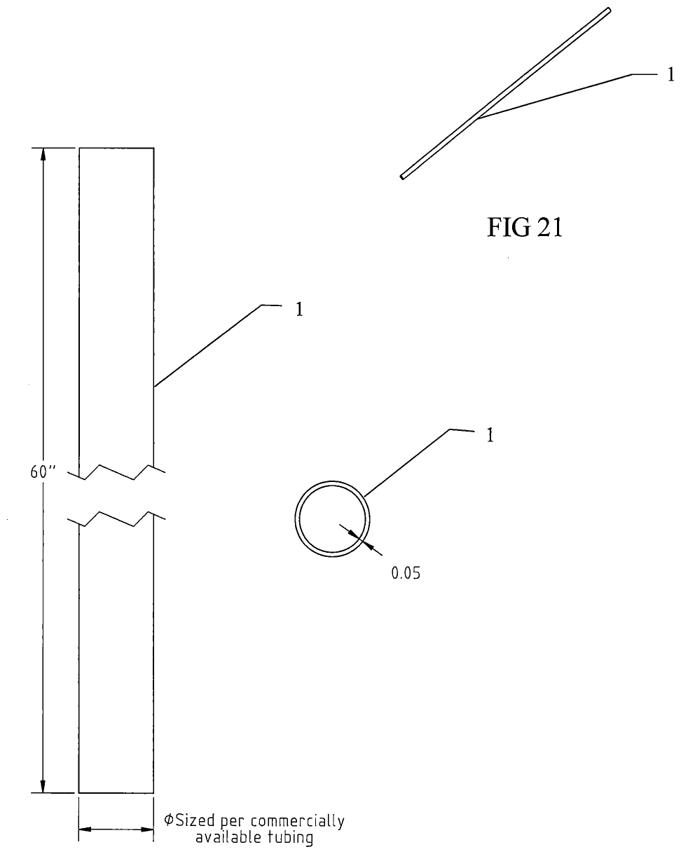

FIG. 21 is an isometric view of tube body 1 further showing a side view and front view of tube body 1 with preferred embodiment.

As described in the various drawings, the nut runner can be sized to adapt to the various dimensions and diameters of all-thread rods by various sizes of interchangeable socket 8. The convenience and numerous benefits of the nut runner are apparent as noted in the various figures.

What is claimed is:

1. A nut runner utility device to drive a fastening nut upwards or downwards on an all-thread rod comprising:
an elongated tube body configured with a front end and a back end;
a pass-through socket;
an interchangeable socket;
a weld nut;
a handle;
a handle bushing;
an internal bushing;
a square drive socket, and
an all-thread rod.

2. A claim as in claim 1 wherein said tube body front end is configured with a pass-through socket, said pass through socket configured to attach an interchangeable socket, said interchangeable socket is configured to engage a fastening nut on an all-thread rod.

3. A claim as in claim 1 wherein said weld nut is configured onto said handle bushing, said internal bushing configured into said handle bushing, said handle bushing is configured onto said tube body.

4. A claim as in claim 3 wherein said handle is configured onto said weld nut.

5. A claim as in claim 1 wherein said tube body back end is configured with a square drive socket, said square drive socket configured to fit a drill, ratcheting wrench, or similar mechanical drive to turn said tube body in a clockwise or counterclockwise direction, thereby running a fastening nut up or down on a vertical all-thread rod.

6. A nut runner utility device as in claim 1 wherein said square drive socket is configured to fit a drill, ratcheting wrench, or similar mechanical drive to turn said tube body in a clockwise or counterclockwise direction, thereby running a fastening nut along a horizontal all-thread rod.

7. A nut runner utility device of claim 1 wherein said tube body can comprise metallic tubing, fiberglass, plastic, nylon, and other material compositions.

8. A nut runner utility device as in claim 1 wherein said interchangeable socket is configured to fit onto said front pass-through socket, said interchangeable socket to comprise various sizes thereby fitting various diameters of all-thread rods.

9. A nut runner utility device as in claim 1 wherein said tube body comprises various lengths to adapt to various lengths of all-thread rods.

10. A nut runner utility device as in claim 1 wherein said square drive socket comprises various sizes to fit onto various drills and mechanical drivers.

11. A method of driving a fastening nut up or down a vertical all-thread rod comprising the steps of:
Providing an elongated tube with a front end and a back end;
configuring a front pass-through socket onto said front of said elongated tube;
configuring an interchangeable socket onto said pass-through socket;
configuring a square drive socket on said back end of said elongated tube;
configuring a handle onto a weld nut on said handle bushing, said handle bushing configured with an internal bushing;
configuring a square drive socket onto said back end of said elongated tube, said square drive to engage with a drill or mechanical device;
holding said handle to engage a fastening nut onto said interchangeable socket, said fastening nut to engage with an all-thread rod; and
turning said square drive clockwise or counterclockwise by said drill to drive said fastening nut up or down a vertical all-thread rod.

12. The method of claim 11 wherein said tube body can comprise metallic tubing, fiberglass, plastic, nylon, and other material compositions.

13. The method of claim 11 wherein said interchangeable socket is configured to fit onto said front pass-through socket, said interchangeable socket to comprise various sizes thereby fitting various diameters of all-thread rods.

14. The method of claim 11 wherein said tube body comprises various lengths to adapt to various lengths of all-thread rods.

15. The method of claim 11 wherein said square drive socket comprises various sizes to fit onto various drills and mechanical drivers.
